(19) United States
(12) Patent Application Publication
(10) Pub. No.: US 2009/0141197 A1
(43) Pub. Date: Jun. 4, 2009

(54) LIQUID CRYSTAL DISPLAY APPARATUS AND METHOD THEREOF FOR PREVENTING TRANSIENT NOISE

(75) Inventor: Young-kook KIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/199,030

(22) Filed: Aug. 27, 2008

(30) Foreign Application Priority Data
Dec. 4, 2007 (KR) 10-2007-0125104

(51) Int. Cl. H04N 3/14; G09G 5/00

(52) U.S. Cl. 348/790; 345/204; 348/E03.016

(57) ABSTRACT

A display apparatus which does not expose a transient phenomenon and an abnormal phenomenon to a user and a method thereof are provided. The display apparatus includes a display which has a unique panel resolution, a receiver which receives an image signal and an additional signal, a display driver, and a controller which, if the additional signal is received, controls such that a specific screen is displayed on the display. Accordingly, a transient phenomenon occurring at the time of a change of a resolution and an abnormal phenomenon occurring if there is a problem in an image signal can be prevented from being exposed to the user without requiring an additional cost and an additional component.

### CROSS-REFERENCE TO RELATED APPLICATIONS

This application claims priority from Korean Patent Application No. 10-2007-125104, filed on Dec. 4, 2007, in the Korean Intellectual Property Office, the disclosure of which is incorporated herein by reference in its entirety.

### BACKGROUND OF THE INVENTION

1. Field of the Invention

Methods and apparatuses consistent with the present invention relate to a display apparatus and a method thereof, and more particularly, to a liquid crystal display apparatus and a method thereof.

2. Description of the Related Art

A monitor, which is one of display apparatuses, is mainly used to display an image received from a personal computer (PC). As the monitor industry has evolved, a demand for a cathode ray tube (CRT) monitor is noticeably reduced, whereas a demand for a liquid crystal display (LCD) monitor is rapidly increased.

One of the reasons why the LCD monitor is preferred over the CRT monitor is that the LCD monitor is slimmer and lighter than the CRT monitor and provides users with greater freedom of installing the monitor. Since there is less space restriction, the users want a bigger screen LCD monitor and accordingly the there is a greater than demand for LCD monitors with bigger screens.

If a resolution of an image changes, a conventional monitor performs a scaling using a scaler embedded therein, thereby outputting an image suitable for a size of the monitor.

However, some monitors do not perform the scaling by themselves. Instead, a video card embedded in a PC connected to the monitor performs the scaling, and the PC transmits an image suitable for the size of the monitor to the monitor and the monitor simply outputs the received image.

In this case, if a resolution of an image changes, the monitor cannot detect the change in the resolution and thus the user is directly exposed to a transient phenomenon which occurs at the time of the change of the resolution.

Also, if there is a problem in an image signal input to the monitor, the monitor may output an undesirable image. Accordingly, there has been a demand for a device that determines a normality/abnormality of an input image signal and does not provide an image corresponding to the image signal to the user if there is an abnormality in the image signal.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a liquid crystal display apparatus which is capable of preventing a user from being exposed to a transient phenomenon which occurs at the time of change of resolution and an abnormal phenomenon which occurs due to a problem in an image signal, and a method thereof.

According to an aspect of the present invention, there is provided a display apparatus which displays an image received from an image providing apparatus, the display apparatus including a display which has a unique panel resolution, a receiver which receives from the image providing apparatus an image signal which has been processed according to the panel resolution and an additional signal which is generated if an original resolution of the image signal before being processed changes, a display driver which drives the display, and a controller which, if the additional signal is received, controls such that a specific screen is displayed on the display.

If the additional signal is received, the controller may control such that a blank screen is displayed on the display.

The blank screen may be provided if a backlight is turned off.

The blank screen may be provided if the image signal is prevented from being received at the display driver.

If the additional signal is received, the controller may control such that a freeze screen is displayed on the display.

The freeze screen may be displayed by displaying a pre-stored image.

The receiver may include a DVI cable connector.

The receiver may receive the processed image signal in a TMDS format, convert the image signal of the TMDS format to an image signal of a TTL format, and transmit the image signal of the TTL format to the display driver.

According to another aspect of the present invention, there is provided a displaying method including, from an image providing apparatus, receiving an image signal which has been processed according to a panel resolution of a display, outputting an image corresponding to the processed image signal; and, if an additional signal indicating that an original resolution of the image has changed is received, displaying a specific screen on the display.

The displaying steps may display a blank screen on the display.

The displaying steps may display a screen on the display with a backlight being turned off.

The displaying step may display a freeze screen on the display.

The displaying step may display the freeze screen on the display by inserting a frame of a pre-stored image between a frame of an image before the original resolution changes and a frame of an image after the original resolution changes.

According to still another aspect of the present invention, there is provided a display apparatus including a display, a receiver which receives an image signal which has been processed according to a panel resolution of the display from an image providing apparatus and transmits a part of the image signal to a controller, a display driver which drives the display to output an image corresponding to the image signal, and a controller which determines a abnormality of the image signal based on the part of the image signal received through the receiver, and, if it is determined that there is an abnormality in the image signal, controls such that a specific screen is displayed on the display.

The part of the image signal may be at least one of a horizontal synchronization signal and a vertical synchronization signal included in the image signal.

The receiver may receive the image signal in a TMDS format and convert the image signal of the TMDS format into an image signal of a TTL format.

If it is determined that there is an abnormality in the image signal, the controller may control such that a screen is displayed on the display with a backlight being turned off.

If it is determined that there is an abnormality in the image signal, the controller may control the display driver to display a blank screen on the display.

If it is determined that there is an abnormality in the image signal, the controller may control the display driver to display a freeze screen on the display.

According to still another aspect of the present invention, there is provided a displaying method including, from an image providing apparatus, receiving an image signal which has been processed according to a panel resolution of a display, transmitting a part of the received image signal to a controller, outputting an image corresponding to the image signal, and determining an abnormality of the image signal based on the part of the image signal, and, if it is determined that there is an abnormality in the image signal, displaying a specific screen on the display.

The receiving step may receive the image signal in a TMDS format.

The part of the image signal may be at least one of a horizontal synchronization signal and a vertical synchronization signal included in the image signal received in the TMDS format.

The displaying step may display at least one of a screen with a backlight being turned off, a blank screen, and a freeze screen.

According to still another aspect of the present invention, there is provided a method for providing information about a change of an original resolution the method including determining whether an original resolution of an image signal has changed or not, if it is determined that the original resolution of the image signal has changed, processing the image signal according to a panel resolution of a display apparatus, and generating an additional signal indicating that the original resolution of an image corresponding to the image signal has changed and transmitting the additional signal to the display apparatus along with the processed image signal.

### BRIEF DESCRIPTION OF THE DRAWINGS

Above and other aspects of the present invention will become apparent and more readily appreciated from the following description of the exemplary embodiments, taken in conjunction with the accompany drawings of which:

FIG. 1 is a block diagram illustrating a monitor according to an exemplary embodiment of the present invention;

FIG. 2 is a flowchart illustrating a process of preventing a transient phenomenon from being displayed on the monitor of FIG. 1;

FIG. 3 is a block diagram illustrating a monitor according to another exemplary embodiment of the present invention;

FIG. 4 is a flowchart illustrating a process of preventing an abnormal phenomenon from being displayed on the monitor of FIG. 3;

FIG. 5 is a block diagram illustrating a personal computer (PC) according to an exemplary embodiment of the present invention;

FIG. 6 is a flowchart illustrating a process of transmitting a scaled image signal and resolution change information from the PC of FIG. 5 to the monitor; and

FIGS. 7A to 7C are views illustrating a process of preventing a transient phenomenon and an abnormal phenomenon.

### DETAILED DESCRIPTION OF EXEMPLARY EMBODIMENTS

Certain exemplary embodiments of the present invention will be described in greater detail with reference to the accompanying drawings.

In the following description, the same drawing reference numerals are used for the same elements even in different drawings. The matter defined in the description, such as detailed construction and elements, are provided to assist in a comprehensive understanding of the invention. Thus, it is apparent that the exemplary embodiments of the present invention can be carried out without this specifically defined matter. Also, well-known functions or constructions are not described in detail since they would obscure the invention with unnecessary detail.

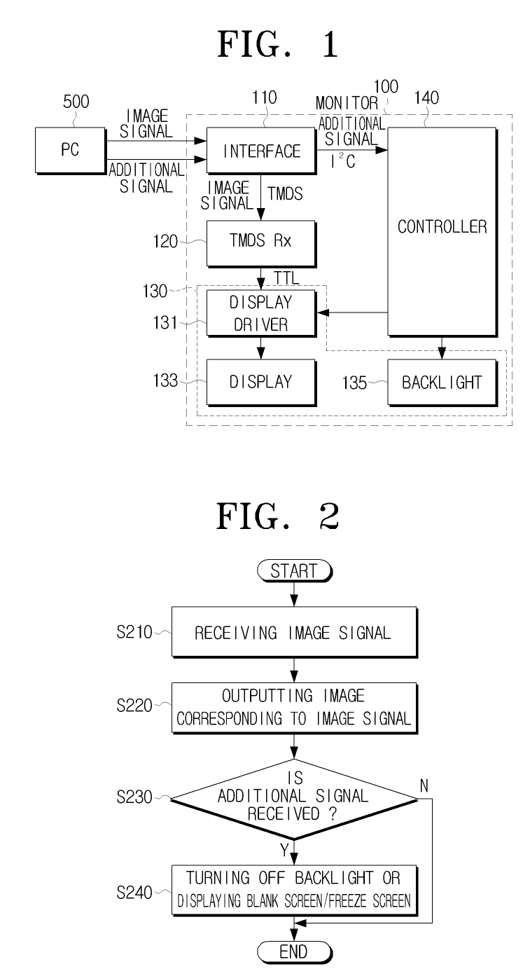

FIG. 1 is a block diagram illustrating a monitor according to an exemplary embodiment of the present invention. Referring to FIG. 1, a monitor 100 according to an exemplary embodiment of the present invention is a display apparatus that displays an image received from a personal computer (PC) 500 through a digital visual interface (DVI) or other types of interfaces available presently or which will be available in the future. The monitor 100 comprises an interface 110, a transition minimized differential signal (TMDS) receiver 120, a display panel 130, and a controller 140. It is noted that the image may be received from other types of host devices such as set-top boxes including IPTV set-top boxes or optical disc player and etc.

The interface 110 is a DVI connector that is connected to the PC 500 through the DVI cable and receives an image signal and an additional signal from the PC 500.

More specifically, the interface 110 receives a scaled image signal. The scaled image signal refers to an image signal which has been scaled by a video card (not shown) (or other types of devices having scaling function) of the PC 500 for an image stored in the PC 500 or an image output from an external device (not shown) connected to the PC 500 to have a resolution according to a panel resolution of the monitor 100.

Also, the interface 110 receives an additional signal indicating that an ‘original resolution’ of the image signal provided from the PC 500 has changed.

If a resolution of an image signal is changed through a scaling, the ‘original resolution’ refers to a resolution of the image signal before being scaled to a panel resolution. Also, if a resolution itself is changed regardless of the scaling, the ‘original resolution’ refers to a previous resolution of the image signal

The ‘original resolution’ of the image signal is changed either if a resolution of an image is changed by a change of a program executed on the PC or if a resolution of an image generated by the PC is changed by user's manipulation.

Also, in another example, it is assumed that an image ‘A’ having a resolution of 1000*500 and an image ‘B’ having a resolution 2000*1000 exist in the PC 500 and a panel resolution of the monitor 100 is 3000*1500. If the image ‘A’ is to be transmitted to from the PC 500 to the monitor 100 and is to be output on the monitor 100, the PC 500 may scale an image signal for the image ‘A’ to have a resolution 3 times the original resolution and transmits the scaled image signal to the monitor 100.

If an image to be output on the monitor 100 changes from the image ‘A’ to the image ‘B’ during the transmission of the scaled image signal to the monitor 100, the PC 500 may scale an image signal for the image ‘B’ to have a resolution 1.5 times the original resolution and transmits the scaled image signal to the monitor 100.

In this case, the ‘original resolution’, which refers to a resolution of an image signal before being scaled, changes from 1000*500 to 2000*1000, and this is because the resolution itself changes. Accordingly, the PC 500 generates an additional signal to inform the monitor 100 that the image signal's original resolution itself has changed.

As a result, if a resolution of an image changes during the reception of the image signal for the image ‘A’ which has been scaled to the panel resolution 3000*1500, the interface 110 receives an image signal for the image ‘B’ which has been scaled to the panel resolution 3000*1500 along with the additional signal indicating that the original resolution has changed.

If the interface 110 is a DVI cable connector as in this embodiment, the interface 110 receives the image signal and the additional signal through a DVI cable, and receives the image signal using a pin which is used in transmitting a TMDS format signal, while receiving the additional signal using a pin which is not used in transmitting the TMDS format signal.

Also, the interface 110 receives the scaled image signal from the PC 500 and transmits it to the TMDS receiver 120, and transmits the additional signal to the controller 140.

The TMDS receiver 120 is an element that receives TMDS format signals. The TMDS receiver 120 receives image signals transmitted in a TMDS format through a plurality of channels and divides the received signals into encoded signals and non-encoded signals.

The TMDS receiver 120 decodes the signals that have been encoded and transmitted through a plurality of channels. Since a DVI cable transmits the signals in a TMDS format, the TMDS receiver 120 receives the image signal which has been encoded at a TMDS transmitter (not shown) of the PC 500 and decodes the image signal.

The image signal decoded by the TMDS receiver 120 includes a RGB (red, green, blue) data signal, a control signal, a horizontal synchronization signal, a vertical synchronization signal, and a data enable signal.

The TMDS receiver 120 converts the decoded image signal into a TTL format signal and transmits it to the display panel 130.

Although the interface 110 is a DVI connector connected to a DVI cable in this embodiment, the interface 110 may be a D-sub connector if the interface 110 is connected to a D-sub cable rather than the DVI cable to receive an analog signal.

Also, although the monitor 100 comprises the TMDS receiver 120 for the purpose of receiving the TMDS signal through the DVI cable in this embodiment, the monitor 100 may comprise an analog-digital converter (ADC) instead of the TMDS receiver for the purpose of converting the analog signal received through the D-sub cable to a digital signal.

That is, the interface 110 is to receive signals from the PC 500 and may be embodied by various cable connectors such as a universal series bus (USB), display port, and a high-definition multimedia interface (HDMI). The interface 110 receives signals of a format corresponding to a cable connector embodied as the interface. The display device described in the present invention may also comprise of other types of display devices such as televisions having capability to connect to host devices capable of outputting images.

The display panel 130 comprises a display driver 131, a display 133, and a backlight 135.

The display driver 131 drives the display 133. The display driver 131 receives the image signal which has been converted into a TTL format signal from the TMDS receiver 120 and drives the display 133. The display 133 displays an image corresponding to the image signal so that a user can view the image.

However, the above description is made on the assumption that the interface 110 is a DVI cable connector. If the interface 110 is one of other cable connectors such as USB, display port, and HDMI rather than the DVI connector, the display driver 131 receives image signals of various formats rather than image signals of a TTL format and drives the display 133.

The backlight 135 is used as a light emitting element at the backside of the display 133 in case that the display 133 is embodied by a LCD panel or a thin film transistor (TFT) which is unable to emit light by itself.

The controller 140 controls entire operations of the monitor 100. In particular, the controller 140 receives the additional signal from the interface 110 in an I²C format.

The I²C signal is a communication protocol between chips on a substrate and a serial communication standard having two lines of a data line and a clock line.

The controller 140 receives the additional signal from the interface 110 in the I²C format, and determines whether the original resolution of the image signal provided by the PC 500 has changed or not.

If the ‘original resolution’ of the image signal is determined to have changed based on the additional signal, the controller 140 outputs a control signal to the display driver 131 to control the display 133.

More specifically, if it is determined that the ‘original resolution’ of the image signal provided by the PC 500 has changed, the controller 140 turns off the backlight 135 or controls the display driver 131 not to output the image signal such that a blank screen is displayed i.e. a black image is displayed on the entire screen. This is to prevent a transient phenomenon such as a noise from being displayed and the user from being exposed to the transient phenomenon at the time that the resolution of the image signal changes. Also, the controller 140 may control the display driver 131 to display a freeze image which has been previously stored in a storage device of the display apparatus or is a previous frame image.

That is, the display apparatus according to the exemplary embodiment of the present invention receives an image signal which has been scaled to a panel resolution at an external device such as a PC and displays the image signal, and, if a scaling ratio is changed as an original resolution is changed, the display apparatus receives information about this change through a communication with the external device and thus prevents an transient phenomenon, which occurs at the time of the change of the original resolution, from being exposed to the user.

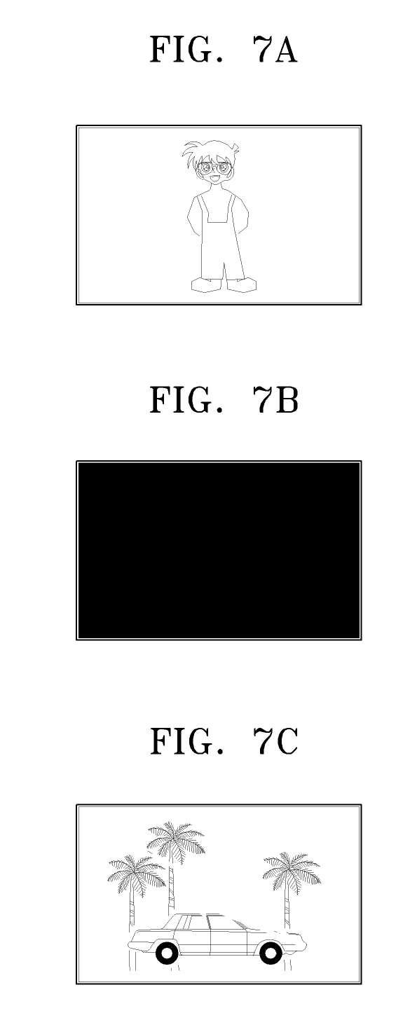

FIGS. 7A to 7C are views illustrating a process of preventing a transient phenomenon from being exposed to the user by displaying a blank screen in which a black image is displayed on the entire screen.

FIG. 7A is a view illustrating an image of an original resolution ‘A’ which has been scaled to a panel resolution and output on the display 133. FIG. 7C is a view illustrating an image of a different original resolution ‘B’ which has been also scaled to the panel resolution and output on the display 133.

If an image to be output on the display 133 changes from the image of FIG. 7A to the image of FIG. 7C during the output of the image of FIG. 7A, a transient phenomenon occurs at the time of the changing of the image since the two images have different original resolutions, and the image output on the display 133 suffers from the transient phenomenon.

The image suffering from the transient phenomenon refers to a broken image or a blurred image which is not desirable.

Accordingly, the controller 140 controls the display driver 131 to output a blank screen made of only a black color as shown in FIG. 7B, which is an image before the transient phenomenon occurs, at the time that the original resolution of the image changes, thereby preventing the transient phenomenon from being exposed to the user.

That is, the controller 140 controls the display driver 131 to insert a frame for a blank image or a freeze image between a frame for the image before the original resolution changes and a frame for the image after the original resolution changes, and display a blank screen or a freeze screen on the display 133.

Accordingly, the user views the freeze screen or the blank screen instead of the transient phenomenon and thus does not have an unpleasant feeling. Also, the user can be prevented from misunderstanding that there occurs a disorder in the display apparatus.

FIG. 2 is a flowchart illustrating a method for controlling the display apparatus of FIG. 1. The following description will be made on the assumption that the interface 110 is a DVI cable connector as described above. As shown in FIG. 2, the TDMS receiver 120 receives an image signal which has been scaled to a panel resolution through the interface 110 in a TMDS format (S210).

After that, the TMDS receiver 120 converts the received image signal into an image signal of a TTL format and outputs the image signal to the display driver 131, and the display driver 131 drives the display 133 to output an image corresponding to the TTL format image signal (S220).

The controller 140 determines whether an original resolution has changed or not by receiving an additional signal (S230).

If it is determined that the original resolution has changed (S230-Y), the controller 140 controls the backlight 135 to be turned off or controls the display driver 131 to display a blank screen or a freeze screen on the display 133 (S240).

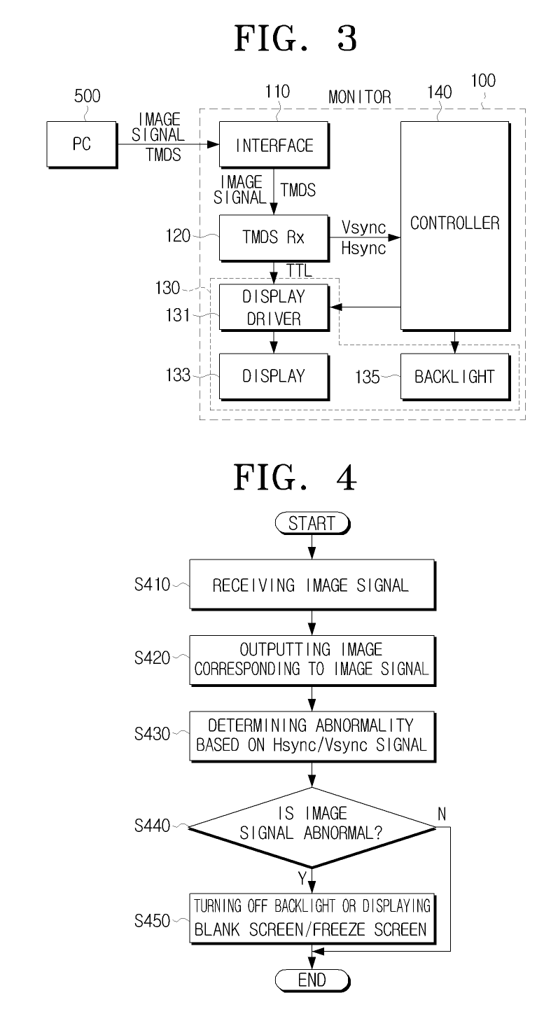

FIG. 3 is a block diagram illustrating a monitor 100 according to another exemplary embodiment of the present invention. The monitor 100 is a display apparatus that outputs an image received from a PC 500. The monitor 100 comprises an interface 110, a TMDS receiver 120, a display panel 130, and a controller 140.

The interface 110, the TMDS receiver 120, the display panel 130, and the controller 140 shown in FIG. 3 are similar to those of FIG. 1 in their functions and operations and thus their detailed descriptions will be omitted. Hereinafter, a process of not displaying an image for an abnormal signal will be mainly described.

The interface 110 is connected to the PC 500 through a DVI cable and is a connector to receive an image signal from the PC 500.

More specifically, the interface 110 receives a scaled image signal. The scaled image signal refers to an image signal which has been scaled by a video card (not shown) of the PC 500 for an image stored in the PC 500 or an image output from an external device (not shown) connected to the PC 500 to have a resolution according to a panel resolution of the monitor 100.

The interface 110 receives the scaled image signal from the PC 500 and transmits it to the TMDS receiver 120.

The TMDS receiver 120 receives the image signal transmitted through a plurality of channels in a TMDS format

The TMDS receiver 120 decodes signals that have been encoded and transmitted through a plurality of channels. The image signal decoded by the TMDS receiver 120 includes a RGB data signal, a control signal, a horizontal synchronization signal, a vertical synchronization signal, and a data enable signal.

The TMDS receiver 120 converts the decoded image signal into a signal of a TTL format and transmits the TTL format signal to the display panel 130, and transmits the horizontal synchronization signal and the vertical synchronization signal of the decoded image signal to the controller 140.

The display panel 130 comprises a display driver 131, a display 133, and a backlight 135.

The display driver 131 receives the TTL format image signal from the TMDS receiver 120 and drives the display 133. The display 133 displays an image corresponding to the TTL format image signal so that a user can view the image.

The backlight 135 is a light emitting element that emits light at the backside of the display 135.

The controller 140 controls entire operations of the monitor 100. In particular, the controller 140 receives the horizontal synchronization signal and the vertical synchronization signal of the decoded image signal from the TMDS receiver 120, and determines a normality/abnormality of the image signal received from the PC 500 based on the received horizontal synchronization signal or the vertical synchronization signal.

If there is an abnormality in the image signal received from the PC 500, there is a distortion in at least one of the horizontal synchronization signal and the vertical synchronization signal received from the PC 500.

If it is determined that there is an abnormality in the image signal received from the PC 500, the controller 140 controls the display driver 131 to display a blank screen or a freeze screen on the display 133. Also, if it is determined that there is an abnormality in the image signal received from the PC 500, the controller 140 turns off the backlight 135 to display no image on the display 133.

Since the blank screen or the freeze screen and the image with a backlight off were described above with reference to FIGS. 7A to 7C, the description will be omitted.

Accordingly, a screen where there is an abnormal signal cannot be exposed to the user.

FIG. 4 is a flowchart illustrating a process of preventing an abnormal phenomenon from being displayed on the monitor 100 of FIG. 3.

Referring to FIG. 4, the TMDS receiver 120 receives an image signal which has been scaled to a panel resolution by the PC 500 in a TMDS format, converts the received image signal into an image signal of a TTL format, and transmits it to the display driver 131, and the display driver 131 receives the TTL format image signal (S410).

The display driver 131 drives the display 133 to output an image corresponding to the image signal (S420).

The controller 140 determines a normality/abnormality of the image signal based on a horizontal synchronization signal or a vertical synchronization signal (S430).

If it is determined that there is an abnormality in the image signal (S440-Y), the controller 140 controls the backlight 135 to be turned off such that no image is output on the display 133, or controls the display driver 131 to display an blank screen or a freeze screen on the display 133 (S450).

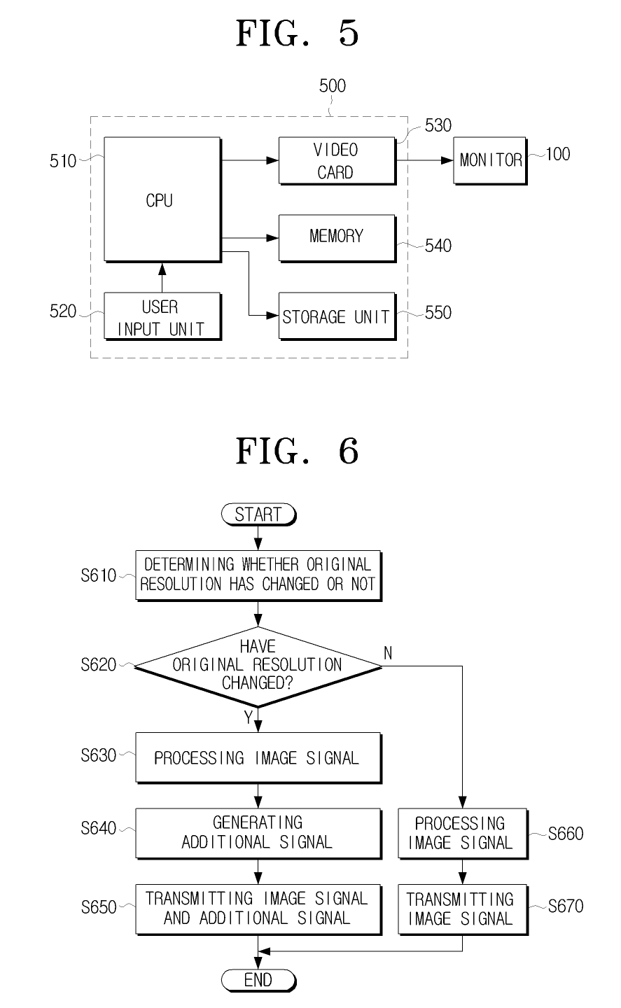

FIG. 5 is a block diagram illustrating a PC 500 according to an exemplary embodiment of the present invention. The PC 500 transmits to a monitor 100 a signal including information that a resolution has changed.

The PC 500 comprises a CPU 510, a user input unit 520, a video card 530, a memory 540, and a storage unit 550.

The CPU 510 controls entire operations of the PC 500 such that a scaled image signal and an additional signal indicating that an original resolution has changed are transmitted to the monitor 100.

The user input unit 520 serves as an interface to transmit a command to change an image to output and thus change a resolution of the image and is a keyboard or a mouse by way of an example. Although the user input unit 520 is described as being included in the PC 500 in this embodiment, it may not be included in the PC 500 in another exemplary embodiment.

If an original resolution of an image signal provided by the PC 500 has changed, the video card 530 scales the image signal according to a panel resolution of the monitor 100 and then outputs the scaled image signal to the monitor 100. Also, the video card 530 outputs an additional signal indicating that the original resolution has changed to the monitor 100 along with the image signal.

The memory 540 stores information about the original resolution of the output image.

The storage unit 550 stores a program for reading out information about an original resolution and a program for detecting a change of the original resolution.

The original resolution information reading program, which is stored in the storage unit 550, is programmed such that the CPU 510 reads out information about an original resolution and stores the information to the memory 540.

The original resolution change detecting program, which is also stored in the storage unit 550, is programmed such that the CPU 510 reads out information about an original resolution from the memory 540 and detects a change of an original resolution.

FIG. 6 is a flowchart illustrating a process of transmitting an image signal scaled to a panel resolution and an additional signal from the PC 500 to the monitor 100 of FIG. 5.

Referring to FIG. 6, the CPU 510 reads out information about an original resolution from the memory 540 and determines whether the original resolution has changed or not (S610).

If the original resolution is determined to have changed (S620-Y), the video card 530 scales an input image signal (S630).

Also, if the original resolution is determined to have changed, the CPU 510 generates information indicating that the original resolution has changed (S640).

After that, the CPU 510 outputs the generated resolution change information and the image signal to the video card 530, and the video card 530 transmits the scaled image signal and the resolution change information to the monitor 100 (S650).

If the original resolution has not changed (S620-N), the CPU 510 outputs the image signal to the video card 530 and the video card 530 scales the input image signal (S660).

If a scaling is completed, the video card 530 transmits the scaled image signal to the monitor 100 (S670).

Accordingly, it is possible to prevent a transient phenomenon from being exposed to the user at the time of the change of the resolution.

In the above embodiments, the PC 500 was described as an apparatus transmitting the scaled image signal in the TMDS format. However, this is merely an example for the convenience of explanation. Any apparatus that can perform a scaling by itself according to a change of a resolution is applied to the present invention.

Also, the monitor 100 was described as an apparatus receiving the scaled image signal of the TMDS format. However, this is merely an example for the convenience of explanation. Any apparatus that can output a scaled image signal can be applied to the present invention.

Also, in the above embodiments, a freeze screen or a blank screen is output for the purpose of preventing a transient phenomenon or an abnormal phenomenon. However, this is merely an example. A specific screen other than the freeze screen or the blank screen may be inserted to prevent the transient phenomenon or the abnormal phenomenon.

Also, the blank screen was described as having a black color. However, other colors may be used for the blank screen.

Also, the horizontal synchronization signal or the vertical synchronization signal included in the image signal is used in determining a normality/abnormality of the image signal. However, this should not be considered as limiting. Another type of signal which is not included in the image signal may be used in determining a normality/abnormality of the image signal.

Also, the additional signal was described as being transmitted in the I²C format. However, this is merely an example for the convenience of explanation. Another communication standard may be used in receiving the additional signal.

Also, in the above embodiments, an image output command to change an original resolution is input through the user input unit. However, it is possible to change the original resolution without using the user input unit. For example, a screen saver may be used.

Also, in the above embodiment, an image signal is transceived between the PC 500 and the monitor 100 using the DVI cable in the TMDS format. However, this is merely an example for the convenience of explanation. Any connector that can transmit the scaled image signal from the PC 500 may be used. For example, the signal may be transmitted using a display port.

As described above, according to the exemplary embodiments of the present invention, a transient phenomenon which occurs if a resolution of an image signal transmitted from the PC 500 to the monitor 100 having no scaler has changed and an abnormal phenomenon which occurs if there is a problem in the image signal are not exposed to the user, and thus, the user does not have an unpleasant feeling when using the PC 500 and the monitor 100.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A display apparatus which displays an image received from an image providing apparatus, the display apparatus comprising:
a display which has a unique panel resolution;
a receiver which receives from the image providing apparatus an image signal which has been processed according to the panel resolution and an additional signal which is generated if an original resolution of the image signal before being processed changes;
a display driver which drives the display; and
a controller which, if the additional signal is received, controls such that a specific screen is displayed on the display.

2. The display apparatus as claimed in claim 1, wherein, if the additional signal is received, the controller controls such that a blank screen is displayed on the display.

3. The display apparatus as claimed in claim 2, wherein the blank screen is provided if a backlight is turned off.

4. The display apparatus as claimed in claim 2, wherein the blank screen is provided if the image signal is prevented from being received at the display driver.

5. The display apparatus as claimed in claim 1, wherein, if the additional signal is received, the controller controls such that a freeze screen is displayed on the display.

6. The display apparatus as claimed in claim 5, wherein the freeze screen is displayed by displaying a pre-stored image.

7. The display apparatus as claimed in claim 1, wherein the receiver includes a DVI cable connector.

8. The display apparatus as claimed in claim 7, wherein the receiver receives the processed image signal in a TMDS format, converts the image signal of the TMDS format to an image signal of a TTL format, and transmits the image signal of the TTL format to the display driver.

9. A displaying method comprising:
receiving an image signal from an image providing apparatus which has been processed according to a panel resolution of a display;
outputting an image corresponding to the processed image signal; and
if an additional signal indicating that an original resolution of the image has changed is received, displaying a specific screen on the display.

10. The displaying method as claimed in claim 9, wherein the displaying steps displays a blank screen on the display.

11. The displaying method as claimed in claim 10, wherein the displaying steps displays a screen on the display with a backlight being turned off.

12. The displaying method as claimed in claim 9, wherein the displaying step displays a freeze screen on the display.

13. The displaying method as claimed in claim 12, wherein the displaying step displays the freeze screen on the display by inserting a frame of a pre-stored image between a frame of an image before the original resolution changes and a frame of an image after the original resolution changes.

14. A display apparatus comprising:
a display;
a receiver which receives an image signal which has been processed according to a panel resolution of the display from an image providing apparatus and transmits a part of the image signal to a controller;
a display driver which drives the display to output an image corresponding to the image signal; and
a controller which determines an abnormality of the image signal based on the part of the image signal received through the receiver, and if it is determined that there is an abnormality in the image signal, controls such that a specific screen is displayed on the display.

15. The display apparatus as claimed in claim 14, wherein the part of the image signal is at least one of a horizontal synchronization signal and a vertical synchronization signal included in the image signal.

16. The display apparatus as claimed in claim 14, wherein the receiver receives the image signal in a TMDS format and converts the image signal of the TMDS format into an image signal of a TTL format.

17. The display apparatus as claimed in claim 14, wherein, if it is determined that there is an abnormality in the image signal, the controller controls such that a screen is displayed on the display with a backlight being turned off.

18. The display apparatus as claimed in claim 14, wherein, if it is determined that there is an abnormality in the image signal, the controller controls the display driver to display a blank screen on the display.

19. The display apparatus as claimed in claim 14, wherein, if it is determined that there is an abnormality in the image signal, the controller controls the display driver to display a freeze screen on the display.

20. A displaying method comprising:
receiving an image signal from an image providing apparatus which has been processed according to a panel resolution of a display;
transmitting a part of the received image signal to a controller;
outputting an image corresponding to the image signal; and
determining an abnormality of the image signal based on the part of the image signal, and if it is determined that there is an abnormality in the image signal, displaying a specific screen on the display.

21. The displaying method as claimed in claim 20, wherein the receiving step receives the image signal in a TMDS format.

22. The displaying method as claimed in claim 21, wherein the part of the image signal is at least one of a horizontal synchronization signal and a vertical synchronization signal included in the image signal received in the TMDS format.

23. The displaying method as claimed in claim 20, wherein the displaying step displays at least one of a screen with a backlight being turned off, a blank screen, and a freeze screen.

24. A method for providing information about a change of an original resolution the method comprising:
determining whether an original resolution of an image signal has changed or not;
if it is determined that the original resolution of the image signal has changed, processing the image signal according to a panel resolution of a display apparatus; and
generating an additional signal indicating that the original resolution of an image corresponding to the image signal has changed and transmitting the additional signal to the display apparatus along with the processed image signal.

25. A displaying method comprising:
receiving an image signal from an image providing apparatus having predetermined resolution, the image signal having been scaled from an original image having an original resolution;
displaying the image corresponding to the received image signal; and
if the original resolution of the original image has been changed, displaying a predetermined screen on the display.

26. The display method of claim 25, wherein the predetermined resolution corresponds to a panel resolution of a display device for displaying the image corresponding to the received image signal.

27. The display method of claim 26, wherein the display device is a liquid crystal display device.

28. The display method of claim 25, wherein the change in the original resolution of the original image is indicated by receiving an additional information from the image providing apparatus.

29. The display method of claim 25, wherein the predetermined screen is a blank screen.

30. The display method of claim 25, wherein the predetermined screen is the state of the received image before the change in the original resolution.

31. The display method of claim 25, wherein the predetermined screen is a specific image stored in the display device.

32. The display method of claim 25, wherein the displaying the predetermined image prevents a transient image noise from being displayed if the resolution of the original image changes.
